(19) United States
(12) Patent Application Publication
(10) Pub. No.: US 2008/0097799 A1
(43) Pub. Date: Apr. 24, 2008

(54) Method for processing data requests

(76) Inventor: Janet Ellen Scribner, Los Angeles, CA (US)

Correspondence Address: SMYRSKI LAW GROUP, A PROFESSIONAL CORPORATION, 3310 AIRPORT AVENUE, SW, SANTA MONICA, CA, 90405, US

(21) Appl. No.: 11/586,773

(22) Filed: Oct. 24, 2006

(51) Int. Cl. G06Q 10/00

(52) U.S. Cl. 705/5

(57) ABSTRACT

A method and system of processing reservation data comprises establishing network communications between at least one user device and a check-in server, collecting information, at the check-in server, from one user device regarding at least one passenger's reservation information, establishing network communications between one or more information sources and the check-in server, and enabling a user to obtain approval status from a travel provider regarding the reservation, said approval status received via at least one user device.

### BACKGROUND OF THE INVENTION

1. Field of the Invention

The present invention relates in general to systems and methods for processing scheduling information, and more specifically to systems and methods for collecting, managing, and communicating information relating to airline passenger check-in status.

2. Description of the Related Art

Current airline reservation and scheduling systems include features and functionality that enable passengers and travel agencies Internet and over-the-air wireless access to peruse flight information, select a flight date and departure time, purchase one or more tickets, and obtain check-in status after ticket purchase and prior to flight. In general, passengers typically access flight-scheduling information over the Internet using a browser-based device, such as a personal computer, personal digital assistant (PDA), or via a web-enabled cellular phone. Passengers or users access this flight information directly through the airline carrier's web-site or through an on-line web-enabled travel agency such as Orbitz®. Travel agencies typically connect directly to a plurality of airline databases and access various carriers' flight-scheduling information in order to provide their customers the widest selection of carriers, travel times, and lowest published fares. Travel agencies can implement their own connectivity directly to each desired airline database or integrate a third party solution such as the Sabre® global distribution system to realize airline database access.

Many of today's passenger airline reservations qualify to receive on-line check-in status available from the airline carrier's website. Eligible passengers connect to the carrier's website during a predetermined time period associated with departure, typically up to 24 hours prior to flight time, and complete the ticketing process. Completing the ticketing process may involve checking-in and printing their boarding pass.

A major commercial problem with regard to airline reservation and scheduling systems has to do with passenger on-line flight check-in status. On-line flight check-in status requires the passenger to have access to a web-enabled browser based device during the on-line check-in time window, typically 24 hours prior to flight departure. In the situation where the passenger does not have access to such a device during this predetermined time window allowing remote check-in, she must wait until she arrives at the airport in order to complete the ticketing process. This becomes problematic when the passenger must arrive earlier than necessary or desired to stand in potentially long lines at the carrier's check-in counter while waiting to check-in.

In addition, it is becoming increasingly popular for airlines to offer their passengers unassigned seating. In this event, the passengers load the plane in boarding groups that board the plane in succession, and select their desired seat as they enter the plane. Obviously, it is desirable to be in the first boarding groups that have priority boarding status in order to have choice of the largest selection of seats available on the plane. The boarding groups are frequently assigned according to the exact time when the passenger obtains flight check-in approval: those who check in first will be in the first boarding groups. If the passenger does not have access to the airline's on-line flight check-in service, or does not arrive at the airport presumably several hours in advance of the flight departure time to obtain check-in approval, the passenger will more than likely be assigned to a latter boarding group and will board the plane after most of the other passengers, thereby significantly limiting their choice of desirable seats.

In light of the above, it would be advantageous to offer a design that improves passenger check-in convenience that overcomes issues and limitations present in previous designs.

### SUMMARY OF THE INVENTION

According to one aspect of the present design, there is provided a method for processing reservation data, comprising establishing network communications between at least one user device and a check-in server, collecting information at the check-in server from one user device regarding at least one set of passenger reservation information, establishing network communications between one or more information sources and the check-in server, enabling a user to obtain approval status from a travel provider regarding the reservation, said approval status received via at least one user device.

According to a second aspect of the present design, there is provided a system for obtaining approval for at least one travel segment. The system comprises a server configured to accept travel data from an individual, and a travel processor configured to receive a request for at least one travel segment related to the individual from the server. The server obtains approval status from the travel processor when the reservation request is approved by the airline processor; and further wherein the server is configured to communicate approval status to the individual.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 illustrates a computer system for use in accordance with one embodiment of the present airline data processing design;

FIG. 2 is a logical representation of the software modules executed by the server in FIG. 1 in accordance with one embodiment of the present design; and

FIG. 3 illustrates a general process flow for PCI request generation and fulfillment in accordance with one embodiment of the present design.

The exemplification set out herein illustrates particular embodiments, and such exemplification is not intended to be construed as limiting in any manner.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

In general, the present design includes a system and method for accepting flight data from an individual such as a passenger, submitting a check-in request based on said flight data, obtaining check-in approval status based on the flight data, and communicating received status to the traveler. Travelers may include a plurality of individuals or passengers possessing one or more itineraries that may consist of one or more trip reservations (i.e. destinations) provided by at least one airline carrier. The present design is an automated information collection system configured to collect and store passenger flight information, mechanize airline carrier on-line check-in submission and approval process, store approval status, and communicate status to the passenger.

Whereas previous systems have been offered that enable online presentation of flight scheduling information with facilities that allow passengers to obtain an “approved” check-in status, those types of designs have required the passenger to have access to a computer or other device to complete the on-line check-in process; and request approved check-in status during the requisite time window of usually 24 hours prior to scheduled flight time. The present design mechanizes the overall passenger on-line check-in process, may improve the passenger's chances of being assigned a desirable boarding group, and may reduce the total time spent at the departure airport. The present design may also reduce the passenger processing burden of both the airlines and the airport by further automating passenger processing. The present design obtains airline check-in approval status on behalf of passengers and communicates this status to each appropriate passenger. The present design thus automates the on-line check-in status process using information externally obtained regarding each passenger reservation. The person checking in need not be the traveler, but may instead be a user having access to the system, presumably properly authenticated.

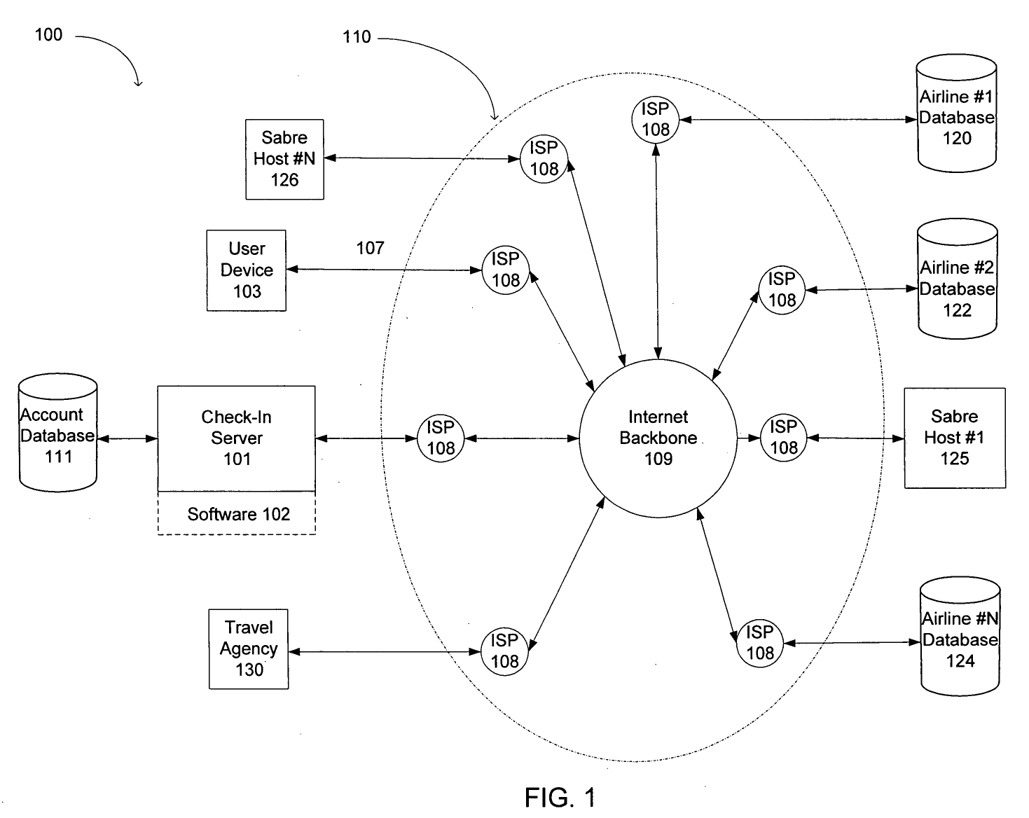

A logical overview of the system is illustrated in FIG. 1. From FIG. 1, a computer system 100 includes a check-in server 101 used generally for obtaining on-line check-in approval status for each passenger/user. Check-in server 101 may be in communications over a communications network 110 with a user device 103 such as, for example, a personal computer, personal digital assistant (PDA), or cell phone. The user device may connect to the Internet backbone 109 using an Internet service provider (ISP) 108. A fixed cable or an over-the-air wireless connection at 107 may support the communications between ISP 108 and the user device 103. An application program, for example an Internet browser or other application, including a downloadable client software program, may provide a graphical or other user interface to the user, and may execute on user device 103 providing access by the user to check-in server 101. A user account on check-in server 101 may be activated or accessed. Once created and activated, the passenger/user may provide authentication information, for example by entering a login name and password. The present design may provide Internet Protocol security and other data protection measures when accessing airline check-in systems to provide secure communications channels. Some of the data protection methods may be distributed and implemented within communications network 110. In addition, the present design may be located in a secure data facility to further protect flight information.

Check-in server 101 may execute software 102, described in more detail below. Information regarding passengers/users, for example a set of one or more airline carrier travel reservation(s) forming a complete travel itinerary held by an airline reservation system, may be stored in account database 111 accessible by check-in server 101. Check-in software 102 may collect passenger pre-check-in (PCI) flight information, for the purposes of obtaining check-in approval status, as provided by each passenger/user via the application program providing the user interface operating on user device 103.

In one example, passenger A provides PCI flight information for two travel segments or reservations representing a first destination and a final destination. Airline carrier #1 will provide service from a home airport to the first destination and airline carrier #2 will provide service between the first destination and the final destination. At the appropriate time, the check-in server 101 may connect to airline carrier #1 and access flight information stored in airline carrier #1 database 120. The check-in server 101 may provide flight information stored in account database 111 associated with the first destination requesting check-in approval. Airline carrier #1 generates the desired check-in approval status and returns this status to the check-in server 101. Check-in server 101 stores the returned status in the account database 111. The check-in server 101 may communicate the passenger/user flight check-in “approved” status obtained from airline carrier #1 to one or more destinations (i.e. user devices). At the appropriate time, the check-in server 101 may connect to airline carrier #2 and access flight information stored in airline carrier #2 database 122. The check-in server 101 may provide flight information stored in account database 111 associated with the final destination requesting check-in approval. Airline carrier #2 generates the desired check-in approval status and returns this status to the check-in server 101. Check-in server 101 may store the returned status in the account database 111. Check-in server 101 may communicate the passenger/user flight check-in “approved” status obtained from airline carrier #2 to one or more destinations (i.e. user devices). The present design is not limited to the number of airline databases or hosting systems and is shown in FIG. 1 as airline #N database 124 and Sabre Host #N 126 respectively.

In the arrangement where the passenger reservations are stored by a third party, for example Sabre Host #1 125 providing reservation and scheduling services for either airline #N database 124, or travel agency 130, the check-in server 101 may connect to Sabre Host #1 at the appropriate time and access flight information stored in Sabre Host #1 database (not shown).

The term “Sabre” is used herein to generically represent any type of travel server, host, or service, and is not limited to the Sabre system currently available. Any travel system having servers and the functional capabilities described would be adequate for implementation of the present invention. In order to clearly discuss the design, the term “Sabre” will be employed with the intent that more is contemplated than merely the current Sabre system.

The check-in server 101 may provide flight information stored in account database 111 associated with the first and final destinations requesting check-in approval for each travel segment. Sabre Host #l may either obtain the desired check-in approval status from airline carrier #1 and airline carrier #2 respectively, or may directly provide the desired check-in approval status on behalf of either or both airline carrier #1 and airline carrier #2, and return these approval statuses to the check-in server 101. Check-in server 101 stores the returned statuses in the account database 111. Check-in server 101 may communicate the passenger/user flight check-in “approved” status obtained from airline carrier #1 and airline carrier #2 to one or more destinations (i.e. user devices). For simplicity, multiple user devices are not shown in the figure. The present design may support a plurality of passengers/users and one or more user devices per passenger/user.

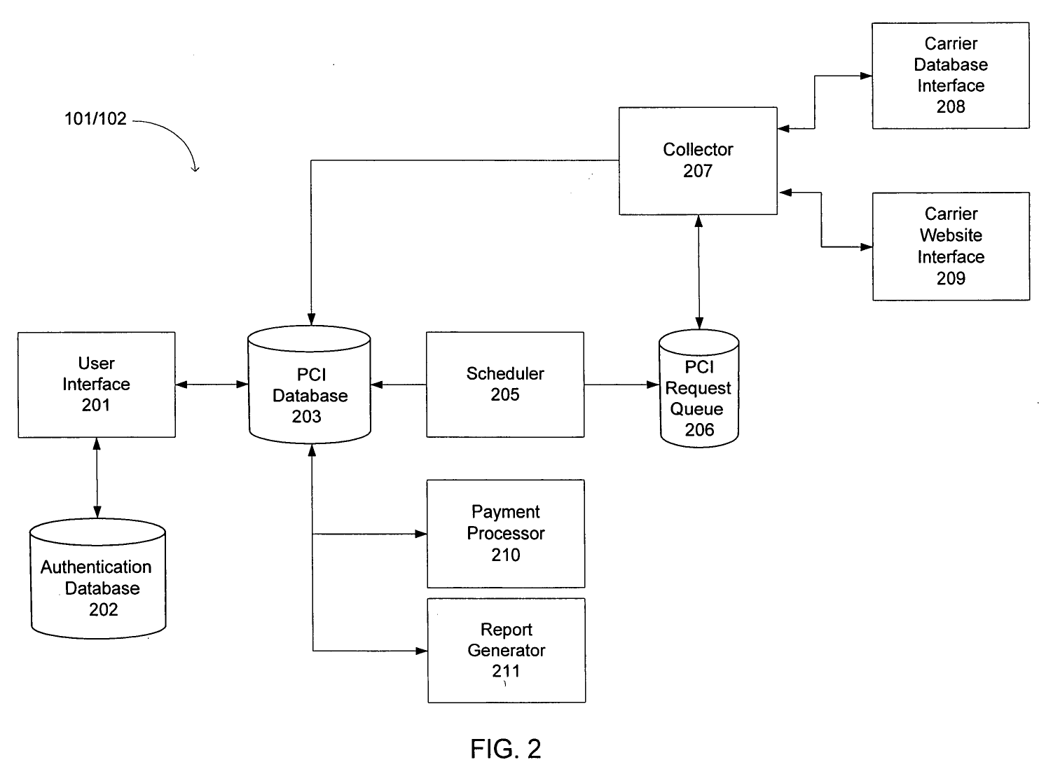

FIG. 2 illustrates the logical arrangement of software modules that may be executed by check-in server 101 as part of software 102. Some or all of these logical modules could, for example, be distributed across multiple servers. User interface 201 may provide an interface to passengers using user device 103 and accept flight information input from such passengers for storage in PCI database 203. Flight information may include but is not limited to airline carrier name, flight number, flight date, flight time, passenger name, reservation number and confirmation number. User interface 201 may store flight information in PCI database 203 for a plurality of passengers/users and may assign a flag indicating new passenger flight information (i.e. data) is ready for processing by scheduler 205. The scheduler 205 may query the PCI database 203 to obtain flight information. The scheduler 205 may build one or more PCI requests in accordance with the flight information, i.e. confirmed reservation, and may stack these requests in a PCI request queue 206. Scheduler 205 may arrange these PCI requests according to flight departure time, airline carrier, and other flight information stored in PCI database 203. Furthermore, the scheduler 205 may assign a request fulfillment time based on published airline carrier on-line check-in policy and flight departure time. For example, if airline #1 publishes an on-line check-in time of 24 hours prior to scheduled flight departure, then scheduler 205 may assign a request fulfillment time of 24 hours prior to the scheduled flight departure time stored in the PCI database 203.

Continuing the example, if airline #2 publishes an on-line check-in time of 48 hours, then the scheduler 205 may assign a request fulfillment time of 48 prior to the scheduled flight departure time stored in the PCI database 203. The scheduler 205 may continuously create new PCI requests and update the contents of the PCI request queue 206 by reordering said PCI requests in accordance with scheduler 205 assigned request fulfillment times as required by newly processed incoming user flight information. Newly processed incoming user flight information may include new flight information, changes to and deletions of previously entered flight information and other modifications to the contents of the PCI database 203.

The scheduler 205 may flag one or more confirmed reservations stored in PCI request queue 206 in the situation where the sum of these reservations identify or represent related travel segments required to arrive at the desired or final destination. Table 1 illustrates an example where three segments are required to reach the final destination. In this example, each travel segment includes a confirmed reservation on airline carrier #1. The present design may flag each of these three segments to identify that they are related segments wherein on-line check-in status is necessary for all segments in order to complete the trip from Virginia to California.

TABLE 1
Three segment example.

| | Departure | | | |
|---|---|---|---|---|
| Segment | Time | Departure/Arrival | Airline | Flight |
| 1 | 0700 | Dulles/Chicago | Carrier #1 | 1527 |
| 2 | 1120 | Chicago/Dallas | Carrier #1 | 982 |
| 3 | 1550 | Dallas/San Jose | Carrier #1 | 13 |

Moreover, the scheduler 205 may flag different airline carrier's confirmed reservation(s) in the situation where one or more airline carriers may be involved, each providing one or some combination of travel segments to form a complete trip. Table 2 illustrates an example where six segments involving four different airline carriers are required to reach the final destination. The present design may flag each of these six segments to identify that they are related segments wherein on-line check-in status is necessary for all segments in order to complete the trip from California to Hong Kong, where D1 represents a first day and D2 a second day.

TABLE 2
Six segment example.

| | Departure | | | |
|---|---|---|---|---|
| Segment | Time | Departure/Arrival | Airline | Flight |
| 1 | D1 0650 | San Jose/Chicago | Carrier #1 | 1527 |
| 2 | D1 1150 | Chicago/New York | Carrier #1 | 982 |
| 3 | D1 1640 | New York/London | Carrier #2 | 13 |
| 4 | D2 0700 | London/Paris | Carrier #2 | 3476 |
| 5 | D2 1010 | Paris/Rome | Carrier #3 | 876 |
| 6 | D2 1450 | Rome/Hong Kong | Carrier #4 | 77 |

The present design affords the ability, within collector 207, to establish communications simultaneously with a plurality of flight information sources and exchange information in accordance with the PCI requests stored within PCI request queue 206. Communications may include but are not limited to providing external interfaces necessary to send and receive data between the present design and flight information sources. Flight information sources may include airline carriers' databases, third party reservation and scheduling systems, travel agency systems, and other appropriate data sources. PCI requests held in PCI request queue 206 may contain a portion of the flight information, all of the flight information, and/or point to locations where flight information necessary for obtaining an approved on-line check-in status resides within the present design, i.e. each airline ultimately holding an in-effect reservation.

At an appropriate time, the airline check-in system is contacted by collector 207 in accordance with the assigned fulfillment request time and affects each PCI request. Collector 207 may send data requesting on-line check-in to the appropriate flight information source as identified within the PCI request. Collector 207 may continue to send and receive data until approved flight status is sent by the airline or entity holding the confirmed reservation as identified within the PCI request. When an approved status is received, collector 207 updates information contained in PCI database 203 to indicate the successfully acquired approval status. In addition, once the entire passenger itinerary is fulfilled (i.e. each segment forming a complete trip), collector 207 may mark each affected PCI request or delete the entire set of requests from the queue. Marked requests may indicate that the user desires to store his information for a period of time enabling him to view his travel history. The present design may mark requests as ready for download to the user's device 103. For example, a user may desire to save his itineraries in an Excel spreadsheet, or other software application suitable for storing the said itinerary data.

User interface 201 may continually monitor the PCI database 203 for content changes resulting from collector 207 processing said PCI requests. When user interface 201 detects such a content change, user interface 201 may establish a connection with the appropriate user device 103, as identified in PCI database 203, and may communicate the acquired approved status to the passenger in accordance to preference information contained in the original request or user profile.

One example of establishing a connection and communicating status may include user interface 201 generating an email containing or conveying approved status successfully obtained and sending this email to a predefined user messaging account. Another example may include the present design dialing a pager number or cellular phone and sending a text message or Short Message Service indicating successful on-line check-in. In the situation where the present design is unable to obtain on-line check-in approval for a particular PCI request, the collector 207 may modify the fulfillment request time by applying an appropriate back-off algorithm to establish a new fulfillment request time and place this modified PCI request back into PCI request queue 206 for further consideration.

The back-off algorithm may adjust or modify the initial fulfillment request time by a predetermined fixed amount responsive to the type of request failure. One example of a PCI request failure may occur when the collector is unable to connect with a flight information source due to a network or airline carrier system outage. Another example may occur when a scheduled flight time has been delayed or postponed, resulting in a new scheduled flight time and thus requiring a recalculated fulfillment request time. In this situation, the collector 207 back-off algorithms may adjust the fulfillment request time to represent 24 hours prior to the newly scheduled flight time, and place this PCI request back into the queue for later processing. The present design may send a message to the passenger to indicate that the flight has been postponed or delayed, or any other event that may require a recalculated fulfillment request time. Other failure conditions may cause the system to advise the user/passenger that a recalculated fulfillment request time is needed.

It should be noted that while the logical representation presented in FIG. 2 of the software illustrates various blocks, modules, and components, the lines of demarcation between the various components are not hard and fast, and certain functionality may be performed by various components, including single components or combination of components, and the functionality described herein is not hard and fast set of requirements. For example, collector 207 may signal user interface 201 each time a PCI request has been satisfied in lieu of flagging the appropriate PCI request in PCI database 203.

In addition, collector 207 may provide information in combination with the on-line check-in approval request to indicate a seat assignment preference or other travel requirements and restrictions when offered by the carrier or carriers. On successfully acquiring a seat assignment or other travel requirements and restrictions, the collector 207 may store this information in the PCI database 203 available for user interface 201 to include in the status message when disseminated to the appropriate passenger.

The present design may obtain sufficient information from both the user and the carrier or database to print hard copies of user and/or carrier specific items, such as boarding passes. Boarding pass printing enables the user to obtain a document that enables her to bypass airport check-in and proceed directly to a gate. Functionality may be provided in the present system wherein the user is approved by the system and he or she can contact the carrier for carrier specific data such as boarding pass information and printing capability. This does not enhance functionality, such as when the user has no computer or internet access, and in general printing and boarding pass type functionality is provided by the present system.

Thus the approval message generated and transmitted by the present design may include information required by the passenger/user to either print the boarding pass directly at his convenience, or obtain the printed boarding pass. Typically, the message may contain information regarding the website or other location that may be accessed by the user to obtain a printed boarding pass.

The present design may obtain on-line check-in approval status using a direct access method or a website access method to exchange information stored in flight information sources such as airline reservation and scheduling systems. The collector 207 may access flight information sources via a direct link open portal access method, wherein the necessary data is directly submitted to a carrier database interface 208. Collector 207 may physically and electrically emulate open or proprietary interfaces associated with connecting to a flight information source check-in system to realize an exchange of information for obtaining an approved on-line check-in status. In the website access arrangement, collector 207 may access the airline website interface 209 in the same manner as a user would by inputting data into the appropriate airline web-pages requesting check-in approval and extracting data from said airline web-pages to obtain approved status and other relevant information. In one arrangement, the collector 207 may establish both access methods, wherein the primary method employs the direct access and a back-up method is realized using the website access method.

The present design may provide an additional access method wherein a software program is downloaded to the user device 103 whether it be a PDA, laptop computer, cell phone, or other device suitable for executing this software program. In this arrangement, the software program is configured to accept the passengers/users flight itinerary data and may transmit this data to the check-in server 101 via user interface 201. When check-in server 101 receives the approved check-in status from the airline carrier, user interface 201 may then forward or communicate this status to the user device 103 for presentation by said software program.

Moreover, the present design may be utilized in a third party arrangement, for example travel agents and agencies, on-line travel reservation companies (e.g. Orbitz, Expedia, etc.), and airline carriers. In this arrangement, the present design may be configured to accept their passenger's flight information data either manually or through an electronic interface. Once the third party data is received, the present design may process this information in the same manner as described above for an individual user to obtain the desired on-line check-in approval status.

In addition, user interface 201 may provide user authentication services by querying authentication database 202 with user provided login information such as user name and password. Although authentication is shown and described in this example implementing a single factor security mechanism, the present design is not limited to providing a single factor security mechanism.

Optional components include payment processor 210, which may execute some or all of the payment processing and accounting functions associated with the present design on-line check-in processing facilities. The user/passenger, third party, or airline may select a payment arrangement, such as charging a credit card or debiting a bank account, and the payment process realized within payment processor 210 will bill or charge that institution according to activities within the billing period. The billing period may be very short for a single passenger/user requiring immediate payment prior to processing any associated PCI requests. The billing period for an entity such as a travel agency may be set to monthly, or any appropriate cycle and may not be due until after a certain volume of PCI requests have been satisfied. Payment processor 210 may also provide an interface to support third party payment engines such as First Data.

Report generator 211, also optional, collects information regarding each reservation, the actions of the passenger/user (e.g. time user submits flight information), the status obtained, number of PCI requests waiting in queue for processing, and other relevant information computed within the present design or provided to the present design. Report generator 211 may compile the information as desired in a report format, such as a spreadsheet or other document format. For example, a user can receive a report, either on demand or periodically, showing previous or pending PCI request activities. The result is a generally configurable set of reports that may be generated by report generator 211 for the benefit of users, airlines, the entity or entities controlling and operating server 101, and any other appropriate entity having an interests in the on-line check-in service provided by the present design. The report generator 211 may therefore generate and optionally send periodic reports (e.g. daily, weekly, or monthly) to some or all authorized parties. Report generator 211 may communicate with, for example, payment processor 210 to obtain billing status information by user. Report generator 211 may also provide an interface to support third party report engines such as Crystal Reports®.

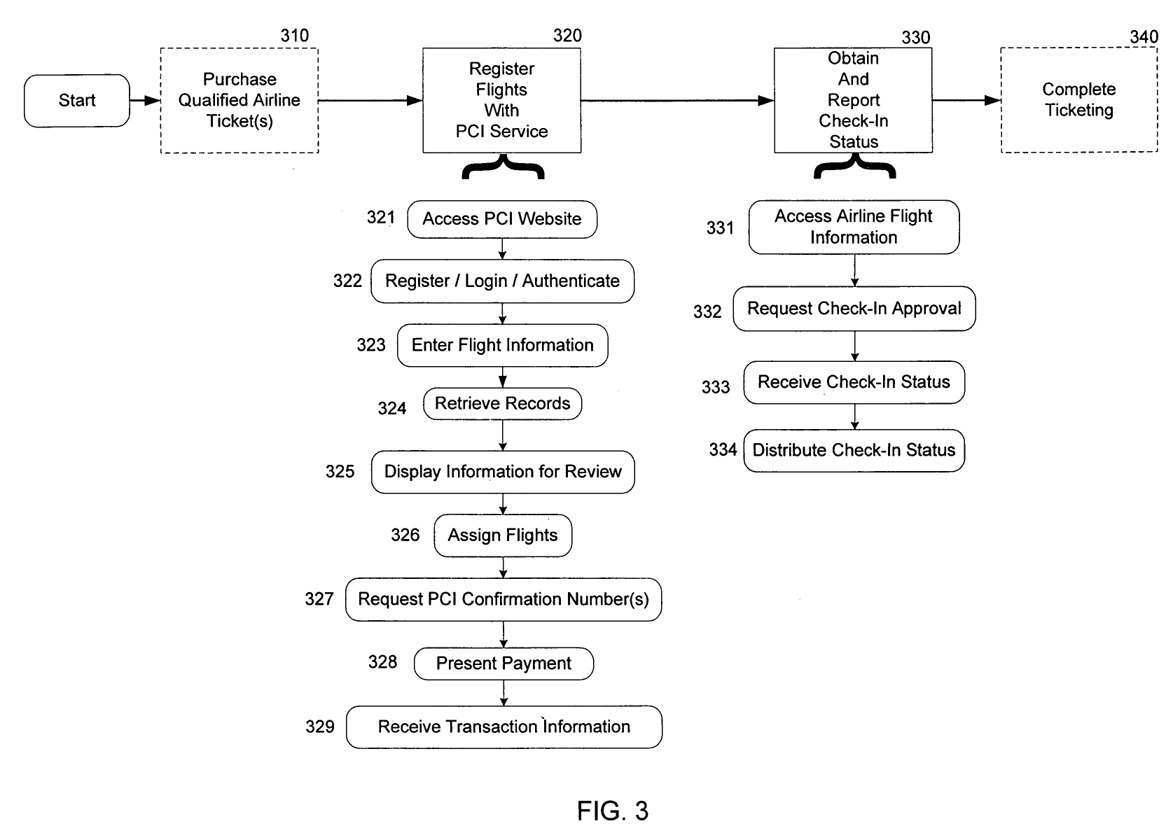

A general process flow is illustrated in FIG. 3 for check-in server 101 executing software 102 that collects, utilizes and provides airline passenger flight information for the purpose of obtaining on-line flight check-in status from the airlines for passengers. The present design may be viewed as four separate sub-process flows: purchase qualified airline ticket at 310, register flights with PCI service at 320, obtain and report check-in status at 330, and complete ticketing at 340. The process flow associated with purchase qualified airline ticket at 310 and complete ticketing at 340 are realized by systems outside of the present design but are shown in FIG. 3 for completeness.

Prior to using the present design, passengers would visit an airline website or contact a travel agent to purchase qualified airline tickets at 310 for a flight or flights. Qualified airline tickets are travel fares sold by airlines that enable the passenger to obtain check-in approval status using the airlines website on-line check-in facility. After purchasing one or more flights or flight segments, the passenger may then register one or more of the flights with the PCI service at 320.

From FIG. 3, point 321 indicates that the user (e.g. passenger, third party reservation and scheduling entity, or airlines) may activate the PCI website realized by check-in server 101 and access check-in server 101. At point 322 the user identifies whether she is a new user to the system, a previously registered user, or desires to be a guest user. A new user may register with check-in server 101 by providing various required account and authentication information. The check-in server 101 compares the authentication information to existing user login name and passwords to ensure uniqueness. If unique, check-in server 101 registers the passenger/user. At this point, check-in server may also provide a guest user account authentication mechanism for those who do not wish to register or for those who intend to be one time users. After successful registration, or if already registered, the user may authenticate with check-in server 101 at point 322.

Once authenticated, the user is requested to either enter new flight information (e.g. airline name, passenger name, reservation number, etc.) or review current flight information at point 324. If new flight information is entered, the check-in server 101 may access the airline's website flight information at point 324 and present it to the user at point 325. Alternatively, a user that may have already registered one or more flights may access that information directly by entering their pre-check-in confirmation number(s) at point 323 in order to retrieve and view all active and pending future itinerary information records. An active record represents a flight that has already been assigned by the passenger for check-in server 101 to acquire on-line check-in status. A pending record represents a scheduled flight not yet assigned by the passenger, but available for assigning, for check-in server 101 to acquire on-line check-in status.

The present design may generate a PCI confirmation number and assign this number to entered passenger flight information. The present design may associate a PCI confirmation number with one reservation, or associate a PCI confirmation number with an itinerary consisting of many travel reservations or segments. The present design may provide one or more PCI confirmation numbers after payment is received from passenger/user. The PCI confirmation number indicates the present design has successfully received a passenger's flight information and is used to identify this set of flight information stored in PCI database 203. The check-in server may retrieve the appropriate records from PCI database 203 according to the new flight information or PCI confirmation numbers input by the user at point 323 and present this information to the user at point 325. The user may review his current flight information at point 325, especially in the situation where the user may have more than one stored itinerary and/or view a history of their activities (i.e. inactive or completed flights). Once the user determines which itinerary they desire to obtain on-line check-in status, the user may request all available or select certain flights for pre-check-in registration. Passengers assigning flights for PCI registration indicate their desire for on-line check-in status to be obtained by the present design on their behalf. At point 326, the user may also un-register selected flight segments to withdraw or remove them from the PCI database 203.

Once the user has selected some or all of the flight segments to be registered for pre-check-in, the user may request PCI confirmation number(s) from check-in server 101 at point 327. The check-in server may request the user to present payment prior to providing the PCI confirmation numbers at 328. The user may post payment at point 328 by either entering their payment information or reviewing default payment information pre-populated from profile information stored in PCI database 203. Check-in server 101 may then send payment information to the credit card company or other financial institution for approval. On successful payment, the check-in server 101 presents transaction information to the user. The transaction information presented to the user at point 329 summarizes the transaction and may provide the itinerary selected, payment receipt, PCI status, PCI confirmation number and other relevant information. After payment is received and verified, the check-in server may place a PCI request on the PCI request queue 206 for the purposes of obtaining on-line check-in status at the appropriate time.

After the user successfully registers flights with the PCI service at point 320, the check-in server 101 may obtain and report check-in status at 330. At the appropriate time, as determined by the fulfillment request time associated with each PCI request, the check-in server may access the airline website or database to obtain flight information associated with said PCI request(s) at point 331. Check-in server 101 may send and receive information to and from the airlines on-line check-in status facility to request check-in approval at 332. The airline on-line check-in facility generates and returns check-in status to check-in server 101 at point 333. Check-in server 101 may distribute the received statuses to the user, based on preference information stored in PCI database 203. Simply put, check-in server 101 may communicate with user device 201 to disseminate check-in status information obtained from the airlines on their behalf at point 334.

At this point, the passenger is provided information regarding boarding pass printing associated with the checked-in flight segments. The check-in server 101 may transmit printing data to the user, based on preference information stored in PCI database 203, so that the boarding pass may be available for printing immediately through the selected user device 103. Alternately, the user may be provided with information as to other options available to print their boarding pass, such as directly through the airline website.

After a passenger receives an approved check-in status from check-in server 101, the passenger must visit the appropriate airline carrier to begin the travel process.

As may be appreciated by the foregoing discussion, the present system may be employed to secure a flight boarding position if the ability to check in is offered at a time inconvenient for the user, such as when the user is asleep or when otherwise occupied conducting business while traveling or has no access to user device 103. The system records the user preference for ticket completion, has available the carrier's restrictions in a database (such as ticketing and boarding passes can only be completed after 12:00 midnight the day before the scheduled flight) and completes ticketing, such as obtaining a boarding pass, and provides the necessary information or documentation to the user. In this manner, a user or authorized person can obtain the requisite items needed to ensure a desirable boarding position, to experience the convenience of automating yet one more task in the increasingly cumbersome and arduous flight process, and to promote a pleasant travel experience.

The present design may alternately be employed to accommodate hotel check-in, car rental check-in, and other travel arrangements associated with the passenger's flight information by applying the same system and method previously described for airline travel. The present design is not limited to travel reservations, but may be applied in similar situations, for example purchasing sport or show tickets, or for purchasing goods and merchandise on line in certain circumstances once they are made available for sale.

In summary, the present design may form specific passenger flight information queries based on user supplied information, scheduling queries, submitting queries to one or more airline carrier databases, submitting appropriate passenger on-line check-in status data, processing query results, receiving check-in status response, and communicating information relating check-in status response, by providing an automated information collection and reporting system that collects information regarding flight check-in status and presents this information to an individual passenger.

The devices, processes and features described herein are not exclusive of other devices, processes and features, and variations and additions may be implemented in accordance with the particular objectives to be achieved. For example, devices and processes as described herein may be integrated or interoperable with other devices and processes not described herein to provide further combinations of features, to operate concurrently within the same devices, or to serve other purposes. Thus it should be understood that the embodiments illustrated in the figures and described above are offered by way of example only. The invention is not limited to a particular embodiment, but extends to various modifications, combinations, and permutations that fall within the scope of the claims and their equivalents.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for processing reservation data, comprising:
establishing network communications between at least one user device and a check-in server;
collecting information, at the check-in server, from one user device regarding at least one set of passenger reservation information;
establishing network communications between one or more information sources and the check-in server; and
enabling a user to obtain approval status from a travel provider regarding the reservation, said approval status received via at least one user device.

2. The method of claim 1, wherein said enabling comprises:
submitting on-line check-in requests based on said flight information;
obtaining check-in approval status from a travel entity;
storing received approval status; and
disseminating status information from the check-in server to the user device.

3. The method of claim 1, wherein the information collected at the check-in server comprises information relating to at least one travel segment.

4. The method of claim 2, further comprising enabling the user to maintain the status information in a desired format, and said maintaining enables the user to obtain a preferred status with the travel entity.

5. The method of claim 2, wherein the status information disseminated comprises flight boarding information.

6. The method of claim 3, wherein information relating to at least one travel segment comprises at least one specific flight identifier comprising one from a group comprising flight number and flight time.

7. A method of obtaining flight registration approval for at least one travel segment, comprising:
accepting travel data from an individual, submitting a check-in request for at least one travel segment related to the individual to a travel processor;
obtaining check-in approval status from the travel processor when the check-in request is approved by the airline processor; and
communicating check-in approval status to the individual.

8. The method of claim 7, wherein said obtaining comprises:
submitting on-line check-in requests to the travel processor based on said travel data information; and
storing check-in approval status at the travel processor.

9. The method of claim 7, wherein the travel data comprises information relating to at least one travel segment.

10. The method of claim 7, further comprising enabling the user to maintain the check-in approval status in a desired format, and said maintaining enables the user to obtain a preferred status with a travel entity associated with the travel data.

11. The method of claim 7, wherein the check-in approval status communicated comprises flight boarding information.

12. The method of claim 9, wherein information relating to at least one travel segment comprises at least one specific flight identifier comprising one from a group comprising flight number and flight time.

13. A system for obtaining approval for at least one travel segment, comprising:
a server configured to accept travel data from an individual;
a travel processor configured to receive a request for at least one travel segment related to the individual from the server;
wherein the server obtains approval status from the travel processor when the request is approved by the airline processor; and further wherein the server is configured to communicate approval status to the individual.

14. The system of claim 13, further comprising a user device, and wherein the user device is configured to communicate with the server.

15. The system of claim 13, further comprising a database accessible by the travel processor and configured to enable determining status of a traveler and travel segment.

16. The system of claim 13, further comprising an authentication database accessible by the server, the authentication database comprising user information and configured to enable access by the user device to server functionality.

17. The system of claim 13, wherein the server has access to a database, a scheduler, a request queue, and a collector.

18. The system of claim 17, wherein the server further has access to a payment processor.

19. The system of claim 17, wherein the server further has access to a report generator.

20. The system of claim 17, wherein the collector is configured to collect information related to the individual from the travel processor.
